(19) United States
(12) Patent Application Publication
(10) Pub. No.: US 2025/0007118 A1
(43) Pub. Date: Jan. 2, 2025

(54) CONTACT SHEET METAL MEMBER AND ENERGY STORAGE ELEMENT

(71) Applicant: VARTA Microbattery GmbH, Ellwangen Jagst (DE)

(72) Inventors: Waldemar FRANK, Ellwangen (DE); Michael GEIGER, Ellwangen (DE); Dominik KIENINGER, Rainau (DE)

(21) Appl. No.: 18/751,387

(22) Filed: Jun. 24, 2024

(30) Foreign Application Priority Data
Jun. 27, 2023 (EP) 23181925.1

(51) Int. Cl. H01M 50/533; H01M 10/04; H01M 10/0525; H01M 10/0587; H01M 50/107; H01M 50/119; H01M 50/152; H01M 50/159; H01M 50/184; H01M 50/186

(52) U.S. Cl. CPC H01M 50/533; H01M 10/0431; H01M 10/0525; H01M 10/0587; H01M 50/107; H01M 50/119; H01M 50/152; H01M 50/159; H01M 50/184; H01M 50/186

(57) ABSTRACT

A contact sheet metal member includes a first contacting section for contacting a first component of an energy storage element, a second contacting section configured for contacting a second component of the storage element, and a connecting section disposed between the first contacting section and the second contacting section. The first contacting section, the second contacting section, and the connecting section have a top side and a bottom side. The top side of the connecting section faces the bottom side of the first contacting section and the bottom side of the connecting section faces the top side of the second contacting section. The member further includes a first bending zone and a second bending zone. The second contacting section has a recess or an aperture that forms a receptable for the first bending zone.

### CROSS REFERENCE TO RELATED APPLICATIONS

This application claims benefit to European Patent Application No. EP 23181925.1, filed on Jun. 27, 2023, which is hereby incorporated by reference herein.

### FIELD

The present disclosure relates to a contact sheet metal member and an energy storage element provided therewith.

### BACKGROUND

Electrochemical energy storage elements can convert stored chemical energy into electrical energy through virtue of a redox-reaction. The simplest form of an electrochemical energy storage element is the electrochemical cell. It comprises a positive and a negative electrode, between which a separator is arranged. During a discharge, electrons are released at the negative electrode as a result of an oxidation process. This results in an electron current that can be drawn off by an external electrical consumer, for which the electrochemical cell serves as an energy supplier. At the same time, an ion current corresponding to the electrode reaction occurs within the cell. This ion current crosses the separator and is made possible by an ion-conducting electrolyte. The separator thus prevents direct contact between the electrodes. At the same time, however, it enables electrical charge equalization between the electrodes.

If the discharge is reversible, i.e. if it is possible to reverse the conversion of chemical energy into electrical energy during discharge and charge the cell again, this is said to be a secondary cell. The common designation of the negative electrode as the anode and the designation of the positive electrode as the cathode in secondary cells refers to the discharge function of the electrochemical cell.

Secondary lithium-ion cells are used as energy storage elements for many applications today, as they can provide high currents and are characterized by a comparatively high energy density. They are based on the use of lithium, which can migrate back and forth between the electrodes of the cell in the form of ions. The negative electrode and the positive electrode of a lithium-ion cell are generally formed by so-called composite electrodes, which comprise electrochemically inactive components as well as electrochemically active components.

In principle, all materials that can absorb and release lithium ions can be used as electrochemically active components (active materials) for secondary lithium-ion cells. For example, carbon-based particles such as graphitic carbon are used for the negative electrode. Active materials for the positive electrode can be, for example, lithium cobalt oxide (LiCoO₂), lithium manganese oxide (LiMn₂O₄), lithium iron phosphate (LiFePO₄) or derivatives thereof. The electrochemically active materials are generally contained in the electrodes in particle form.

As electrochemically inactive components, the composite electrodes generally comprise a flat and/or strip-shaped current collector, for example a metallic foil, which serves as a carrier for the respective active material. The current collector for the negative electrode (anode current collector) can be made of copper or nickel, for example, and the current collector for the positive electrode (cathode current collector) can be made of aluminum, for example.

Furthermore, the electrodes can comprise an electrode binder (e.g. polyvinylidene fluoride (PVDF) or another polymer, such as carboxymethyl cellulose), conductivity-improving additives and other additives as electrochemically inactive components. The electrode binder ensures the mechanical stability of the electrodes and often also the adhesion of the active material to the current collectors.

As electrolytes, lithium-ion cells usually comprise solutions of lithium salts such as lithium hexafluorophosphate (LiPF₆) in organic solvents (e.g. ethers and esters of carbonic acid).

The composite electrodes are generally combined with one or more separators to form an electrode-separator assembly when manufacturing a lithium-ion cell. The electrodes and separators are often, but not necessarily, joined together under pressure, possibly by lamination or bonding. The basic functionality of the cell can then be established by impregnating the assembly with the electrolyte.

In many embodiments, the electrode-separator assembly is formed in the form of a winding or processed into a winding. In the first case, for example, a ribbon-shaped positive electrode and a ribbon-shaped negative electrode as well as at least one ribbon-shaped separator are fed separately to a winding machine and spirally wound into a winding with the sequence positive electrode/separator/negative electrode. In the second case, a ribbon-shaped positive electrode and a ribbon-shaped negative electrode as well as at least one ribbon-shaped separator are first combined to form an electrode-separator assembly, for example by applying the aforementioned pressure. In a further step, the assembly is then wound up.

For applications in the automotive sector, for e-bikes or for other applications with high energy requirements, such as in electric tools, lithium-ion cells with the highest possible energy density are required that are also capable of withstanding high currents during charging and discharging.

Cells for the applications mentioned are often designed as cylindrical round cells, for example with a form factor of 21×70 (diameter*height in mm). Cells of this type comprise an assembly in the form of a winding. Modern lithium-ion cells of this form factor can achieve an energy density of up to 270 Wh/kg.

WO 2017/215900 A1 discloses cylindrical round cells in which the electrode-separator assembly and its electrodes are ribbon-shaped and in the form of a winding. The electrodes each have current collectors loaded with electrode material. Oppositely polarized electrodes are arranged offset to each other within the electrode-separator assembly so that longitudinal edges of the current collectors of the positive electrodes protrude from the winding on one side and longitudinal edges of the current collectors of the negative electrodes protrude from the winding on another side. For electrical contacting of the current collectors, the cell has a contact sheet metal member which sits on one end face of the winding and is connected to a longitudinal edge of one of the current collectors by welding. This makes it possible to electrically contact the current collector and thus also the associated electrode over its entire length. This significantly reduces the internal resistance within the described cell. As a result, the occurrence of large currents can be absorbed much better and heat can also be dissipated better from the winding.

Depending on the design of an energy storage element, it may be necessary to connect the contact sheet metal member to a part of its housing. This is shown, for example, in FIG. 1 of WO 2021/239490 A1, where a current conductor 107 is used to bridge a distance within the housing, namely the distance between a contact sheet metal member 105 and a lid 102. This inevitably results in a dead volume, which contributes negatively to the energy density of the energy storage element shown.

A contact sheet metal member is known from EP 3916891 A1, which is present in the finished cell in an S-shaped fold and not only makes large-area contact with an electrode-separator assembly, but also bridges the distance to a multi-part lid at the same time. By using such a contact component, the aforementioned dead volume can be reduced.

### SUMMARY

In an embodiment, the present disclosure provides a contact sheet metal member. The contact sheet metal member includes a first contacting section configured to contact a first component of an energy storage element, a second contacting section configured for contacting a second component of an energy storage element, and a connecting section disposed between the first contacting section and the second contacting section. The first contacting section has a top side and a bottom side. The second contacting section has a top side and a bottom side. The connecting section has a top side and a bottom side. The top side of the connecting section faces the bottom side of the first contacting section and the bottom side of the connecting section faces the top side of the second contacting section. The contact sheet metal member further includes a first bending zone in which the contact sheet metal member is bent along at least one bending line and a second bending zone in which the contact sheet metal member is bent along at least one second bending line. The first bending zone connects the first contacting section and the connecting section. The second bending zone connects the second contacting section and the connecting section. The second contacting section has a recess or an aperture that forms a receptable for the first bending zone.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a view of a first embodiment of a contact sheet metal member;

FIG. 2 shows a second embodiment of a contact sheet metal member;

FIG. 3 shows a third embodiment of a contact sheet metal member;

FIG. 4 shows an electrode-separator assembly which can be part of an energy storage element, as well as its components;

FIG. 5 shows a part of a cross-section through a lid assembly; and

FIG. 6 is a general view (cross-sectional view) of an embodiment of an energy storage element.

### DETAILED DESCRIPTION

The present disclosure provides energy storage elements which are characterized by a high energy density. In particular, the present disclosure provides for further improving contact sheet metal members such as the one mentioned in EP 3916891 A1.

The contact sheet metal member is intended for use in an energy storage element comprising an electrode-separator assembly in a housing. It is used to make electrical contact with an electrode of the electrode-separator assembly and is intended to connect it to a metallic part of the housing or to an electrical pole passing through the housing. The contact sheet metal member has the following features a. to e:

a. It comprises a first contacting section having a top side and a bottom side, which is provided for contacting with a first component of an energy storage element.

b. It comprises a second contacting section having a top side and a bottom side, which is provided for contacting with a second component of an energy storage element.

c. It comprises, between the first contacting section and the second contacting section, a connecting section having a top side and a bottom side, the top side of the connecting section facing the bottom side of the first contacting section and the bottom side of the connecting section facing the top side of the second contacting section.

d. The first contacting section and the connecting section are connected to each other via a first bending zone in which the contact sheet metal member is bent along at least one bending line, preferably along a first bending line.

e. The second contacting section and the connecting section are connected to each other via a second bending zone in which the contact sheet metal member is bent along at least one bending line, preferably along a second bending line.

The contact sheet metal member is particularly characterized by the following feature f:

f. The second contacting section has a recess or aperture which forms a receptable for the first bending zone.

In order to minimize dead volume, it is desirable for the contact sheet metal member to take up as little space as possible within the housing. It is therefore expedient to press the first contacting section, the connecting section and the second contacting section against each other during assembly, so that the distance between the first and second contacting sections and thus between the bottom side of the first contacting section and the top side of the connecting section and the top side of the second contacting section and the bottom side of the connecting section is as small as possible. Ideally, the bottom side of the first contacting section and the top side of the connecting section as well as the top side of the second contacting section and the bottom side of the connecting section are in direct and preferably flat contact with each other.

The bending zones, especially the first bending zone, can cause problems during this process. When a sheet metal is bent, it springs back a little. In order to bend a sheet metal at a desired angle, the sheet metal generally therefore has to be bent slightly beyond the desired angle. The closer the desired bending angle approaches 180°, the more difficult this becomes.

The recess/aperture ensures that the first bending zone can be pressed into the plane of the second contacting section during the manufacture of the contact sheet metal member or during assembly of an energy storage element, if necessary permanently, and thus facilitates temporary or permanent compaction of the contact sheet and reduction of the dead volume.

In preferred embodiments, the contact sheet metal member is characterized by at least one of the following features a. to c:

a. The first contacting section is aligned parallel to the second contacting section.

b. The connecting section is aligned parallel to the first contacting section and/or the second contacting section.

c. The connecting section forms an angle in the range from −10° to +30° with the first contacting section and/or the second contacting section.

Preferred are the immediately preceding features a. and b. or the immediately preceding features a. and c. in combination with each other. Feature b. is preferred if the aforementioned ideal case occurs in which the bottom side of the first contacting section and the top side of the connecting section as well as the top side of the second contacting section and the bottom side of the connecting section are in direct, preferably flat contact with each other. More often, however, especially before the contact sheet metal member is mounted, there is no direct contact, so that the connecting section makes said angle in the region from −10° to +30° with the first contacting section and/or with the second contacting section.

In the context described, parallel alignment of the contacting sections means that the bottom side of the first contacting section and the top side of the second contacting section are evenly spaced apart. If the bottom side of the first contacting section and the top side of the connecting section and the top side of the second contacting section and the bottom side of the connecting section are aligned in parallel, the distance is generally zero.

It is further preferred that the contact sheet metal member is characterized by at least one of the following features a. and b:

a. The contact sheet metal member has a uniform thickness in the first contacting section and in the second contacting section and in the connecting section.

b. The contact sheet metal member has the same thickness in the connecting section as in the first contacting section and/or the second contacting section.

The immediately preceding features a. and b. are preferably realized in combination.

In some embodiments, the contact sheet metal member is characterized by the following feature a:

a. The contact sheet metal member has at least one bead in the second contacting section, which shows up as a depression on the top side of the second contacting section and as an elevation on the bottom side.

Such a bead can be helpful in forming a good welding contact with an electrode, which is described in more detail below.

In further preferred embodiments, the contact sheet metal member is characterized by at least one of the following features a. to c:

a. In the first contacting section, the contact sheet metal member comprises only regions that extend in the same planar layer.

b. In the second contacting section, the contact sheet metal member comprises only regions that extend in the same planar layer.

c. In the connecting section, the contact sheet metal member comprises only regions that extend in the same planar layer.

The immediately preceding features a. to c. are preferably realized in combination.

In said cases in which the first contacting section is aligned parallel to the second contacting section, the planar layers in which the regions of the first and second contacting sections extend are correspondingly also aligned parallel to each other. The planar layer in which the regions of the connecting section extend, can intersect the other two planar layers, namely if the connecting section is not aligned parallel to the first contacting section and the second contacting section. Generally, this is the case before the contact sheet metal member is mounted.

In alternative preferred embodiments, the contact sheet metal member is characterized by at least one of the following features a. to c:

a. In the first contacting section, the contact sheet metal member comprises only regions that extend in the same planar layer.

b. In the second contacting section, the contact sheet metal member comprises a first region extending in a planar layer and at least one second region not extending in said planar layer.

c. In the connecting section, the contact sheet metal member comprises only regions that extend in the same planar layer.

The immediately preceding features a. to c. are preferably realized in combination.

These alternative preferred embodiments are particularly relevant if the contact sheet metal member comprises the at least one bead in the second contacting section. In this case, the at least one second region comprises the region of the depression or elevation, which in fact does not extend in the plane of the first region.

In cases where the second contacting section comprises the at least one bead, it is preferred that the first contacting section is aligned parallel to the first region of the second contacting section.

In the above context, a planar layer is preferably to be understood as a non-bent layer with a uniform thickness, preferably a thickness which does not exceed the thickness of the contact sheet metal member in the respective section by more than 10%. Preferably, the thickness of the planar layer corresponds to the thickness of the contact sheet metal member in the respective section.

The aperture or recess is preferably located in the planar layer in which the regions or the first region of the second contacting section extend. In the case of an aperture, this is surrounded by the regions or the first region.

The contact sheet metal member is preferably characterized by at least one of the following features a. and b:

a. The first contacting section is a terminal contacting section.

b. The second contacting section is a terminal contacting section.

The immediately preceding features a. and b. are preferably realized in combination. Before the contact sheet metal member is bent along the aforementioned bending lines, the two contacting sections preferably are ends of the contact sheet metal member.

In a further preferred embodiment, the contact sheet metal member is characterized by the following feature a:

a. The first contacting section and the second contacting section and the connecting section each have an aperture which overlap with each other in the direction perpendicular to the second contacting section and/or form a passage, preferably a straight passage, through the sections of the contact sheet metal member.

The passage facilitates the filling of an electrolyte. This allows the electrode-separator assembly to be impregnated with the electrolyte at the end face.

The present disclosure further provides energy storage elements comprising a contact sheet metal member as described above.

Preferably, the energy storage element has the following features a. to c:

a. The energy storage element comprises an electrode-separator assembly with the sequence anode/separator/cathode.

b. The energy storage element comprises an airtight and liquid-tight housing in which the electrode-separator assembly is arranged.

c. The electrode-separator assembly is electrically connected to a part of the housing or to an electrical pole passing through the housing via the contact sheet metal member.

The energy storage element can have a prismatic housing or a cylindrical housing. Accordingly, the electrode-separator assembly also preferably has an essentially prismatic shape or an essentially cylindrical shape. In the case of a prismatic shape, the electrode-separator assembly preferably comprises a plurality of electrodes in a stack, for example electrodes having a rectangular shape. If the electrode-separator assembly has a cylindrical or an essentially cylindrical shape, it preferably comprises ribbon-shaped electrodes wound in a spiral. Preferably separators or layers of a solid electrolyte are arranged between oppositely polarized electrodes. In the case of separators, these and the electrodes are preferably impregnated with an electrolyte.

Preferably, the energy storage element is a cylindrical round cell and accordingly comprises the anode and the cathode preferably in the form of ribbons. Furthermore, it preferably comprises a ribbon-shaped separator or two ribbon-shaped separators. In these preferred embodiments, the energy storage element is characterized by the following features a. to f:

a. The electrode-separator assembly is in the form of a cylindrical winding with a first terminal end face and a second terminal end face and a winding shell in between.

b. The anode of the electrode-separator assembly comprises an anode current collector having a first longitudinal edge and a second longitudinal edge parallel thereto.

c. The anode current collector comprises a main region loaded with a layer of negative electrode material and a free edge strip extending along its first longitudinal edge which is not loaded with the negative electrode material.

d. The cathode of the electrode-separator assembly comprises a cathode current collector having a first longitudinal edge and a second longitudinal edge parallel thereto.

e. The cathode current collector comprises a main region loaded with a layer of positive electrode material and a free edge strip extending along its first longitudinal edge which is not loaded with the electrode material.

f. The anode and the cathode are arranged within the electrode-separator assembly in such a way that the first longitudinal edge of the anode current collector protrudes from the first terminal end face and the first longitudinal edge of the cathode current collector protrudes from the second terminal end face of the electrode-separator assembly.

The end faces are preferably bounded by a circular edge.

In preferred embodiments, the energy storage element is further characterized by the following features a. to c:

a. The housing comprises a metallic housing cup with a terminal circular opening and a lid assembly with a circular edge that closes the circular opening.

b. The top side of the first contacting section is fixed to the lid assembly, preferably welded to the lid assembly.

c. The bottom side of the second contacting section is fixed, preferably welded, to a longitudinal edge of one of the current collectors protruding from one of the end faces of the electrode-separator assembly.

The first component of the energy storage element which is mentioned above in context with the description of the contact sheet metal member can therefore be a lid assembly and the above mentioned second component of the energy storage element can therefore be the electrode-separator assembly described.

In some embodiments it may be preferred to weld an additional, separate sheet metal part onto the longitudinal edge of one of the current collectors protruding from one of the end faces of the electrode-separator assembly, and to fix the bottom side of the second contacting section to this additional sheet metal part, preferably by welding. In this case, the additional sheet metal part electrically connects the longitudinal edge to the contact sheet metal member and the contact sheet metal member electrically connects the additional sheet metal part to a part of the housing or an electrical pole passing through the housing.

The lid assembly is preferably characterized by the following features a. to j:

a. The lid assembly comprises a pole cap with a circular edge.

b. The lid assembly comprises a first metal disc with a circular edge.

c. The lid assembly comprises a second metal disc with a circular edge.

d. The lid assembly comprises an annular seal.

e. The lid assembly comprises an annular insulator.

f. The first metal disc is arranged between the pole cap and the second metal disc.

g. The annular insulator electrically insulates the first metal disc and the second metal disc from each other.

h. The first metal disc is in direct contact with the pole cap.

i. The annular seal is mounted on the circular edge of the pole cap and/or the first metal disc.

j. The top side of the first contacting section is welded to the second metal disc.

In preferred embodiments, the energy storage element is further characterized by the following features a. to c., preferably by the following features a. to d.:

a. The housing cup comprises a bottom, a central section and a closure section in axial sequence.

b. The central section is cylindrical and in the central section the winding shell of the electrode-separator assembly is in contact with the inside of the housing cup.

c. In the closure section, the annular seal of the lid assembly is in press contact with the edge of the pole cap and/or the edge of the first metal disc and the inside of the housing cup.

d. In the closure section, the housing cup has an opening edge defining the circular opening, which is bent radially inwards over the edge of the pole cap and/or the edge of the first metal disc enclosed by the seal and which positively fixes the lid assembly including the seal in the circular opening of the housing cup.

The term “edge of the pole cap and/or the first metal disc” comprises embodiments in which the diameters of the pole cap and the metal disc are either different or the same. The component with the larger diameter is decisive with regard to the press contact, as the seal is in contact with it.

As already described above, the recess/aperture ensures that the first bending zone can be pressed into the plane of the second contacting section during the manufacture of the contact sheet metal member and/or during assembly of an energy storage element.

In some embodiments, the first bending zone remains only temporarily in the recess or aperture. However, this process can also result in a contact sheet metal member in which the first bending zone or a part of the first bending zone permanently protrudes into the recess or aperture and thus preferably also into the aforementioned planar layer in which the regions or the first region of the second contacting section extend. Such a configuration is particularly efficient for reducing said dead volume.

The electrode-separator assembly is preferably in direct contact with the inside of the housing cup. It is preferably in direct contact with the inside of the housing cup. In some embodiments, however, it may be provided to electrically insulate the inside, for example by means of a plastic film. In this case, the electrode-separator assembly is preferably in contact with the inner wall via the film.

The bottom of the housing cup is preferably circular. The housing cup is usually formed by deep drawing. However, it is also possible to form the cup by welding a bottom into a tubular half-part.

Preferably, the height of an energy storage element designed as a cylindrical round cell is in the range from 50 mm to 150 mm. Its diameter is preferably in the range from 15 mm to 60 mm. Cylindrical round cells with these form factors are suitable, for example, for supplying power to electric drives in motor vehicles.

### Embodiment as a Lithium-Ion Energy Storage Element

In a preferred embodiment, the energy storage element is based on lithium-ion technology.

Basically, all electrode materials known for secondary lithium-ion cells can be used for the electrodes of the energy storage element.

Carbon-based particles such as graphitic carbon or non-graphitic carbon materials capable of intercalating lithium, preferably also in particle form, can be used as active materials in the negative electrodes. Alternatively or additionally, lithium titanate (Li₄Ti₅O₁₂) or a derivative thereof can also be contained in the negative electrode, preferably also in particle form. Furthermore, the negative electrode can contain as active material at least one material from the group comprising silicon, aluminum, tin, antimony or a compound or alloy of these materials that can reversibly store and release lithium, for example silicon oxide (in particular SiOₓ with 0<x<2), optionally in combination with carbon-based active materials. Tin, aluminum, antimony and silicon can form intermetallic phases with lithium. The capacity for the receptable of lithium exceeds that of graphite or comparable materials many times over, especially in the case of silicon. Mixtures of silicon and carbon-based storage materials are often used. Thin anodes made of metallic lithium are also suitable.

Suitable active materials for the positive electrodes include lithium metal oxide compounds and lithium metal phosphate compounds such as LiCoO₂ and LiFePO₄. Lithium nickel manganese cobalt oxide (NMC) with the chemical formula LiNiₓMn_{y}Co_{z}O₂ (where x+y+z is typically 1) is also particularly suitable, lithium manganese spinel (LMO) with the chemical formula LiMn₂O₄, or lithium nickel cobalt aluminum oxide (NCA) with the chemical formula LiNiₓCo_{y}Al₂O₂ (where x+y+z is typically 1). Derivatives thereof, for example lithium nickel manganese cobalt aluminum oxide (NMCA) with the chemical formula Li_{1.11}(Ni_{0.40}Mn_{0.39}Co_{0.16}Al_{0.05})_{0.89}O₂ or Li₁₊ₓM-O compounds and/or mixtures of the aforementioned materials can also be used. The cathodic active materials are also preferably used in particulate form.

In addition, the electrodes of the energy storage element preferably contain an electrode binder and/or an additive to improve the electrical conductivity. The active materials are preferably embedded in a matrix of the electrode binder, with neighboring particles in the matrix preferably being in direct contact with each other. Conductive agents have the function of elevating the electrical conductivity of the electrodes. Common electrode binders are based, for example, on polyvinylidene fluoride (PVDF), (Li-)polyacrylate, styrene-butadiene rubber or carboxymethyl cellulose or mixtures of different binders. Common conductive agents are carbon black, fine graphite, carbon fibers, carbon nanotubes and metal powder.

The energy storage element preferably comprises an electrolyte, in the case of a lithium-ion cell in particular an electrolyte based on at least one lithium salt such as lithium hexafluorophosphate (LiPF₆), which is dissolved in an organic solvent (e.g. in a mixture of organic carbonates or a cyclic ether such as THF or a nitrile). Other lithium salts that can be used are, for example, lithium tetrafluoroborate (LiBF₄), lithium bis(trifluoromethanesulfonyl)imide (LiTFSI), lithium bis(fluorosulfonyl)imide (LiFSI) and lithium bis(oxalato)borate (LiBOB).

The nominal capacity of a lithium-ion-based energy storage element designed as a cylindrical round cell is preferably up to 15000 mAh. With the form factor of 21×70, the round cell in an embodiment as a lithium-ion cell preferably has a nominal capacity in the range from 1500 mAh to 7000 mAh, preferably in the range from 3000 to 5500 mAh. With the form factor of 18×65, the round cell in an embodiment as a lithium-ion cell preferably has a nominal capacity in the range from 1000 mAh to 5000 mAh, preferably in the range from 2000 to 4000 mAh.

In the European Union, manufacturer information on the nominal capacity of secondary batteries is strictly regulated. For example, information on the nominal capacity of secondary nickel-cadmium batteries must be based on measurements in accordance with the IEC/EN 61951-1 and IEC/EN 60622 standards, information on the nominal capacity of secondary nickel-metal hydride batteries must be based on measurements in accordance with the IEC/EN 61951-2 standard, information on the nominal capacity of secondary lithium batteries must be based on measurements in accordance with the IEC/EN 61960 standard and information on the nominal capacity of secondary lead-acid batteries must be based on measurements in accordance with the IEC/EN 61056-1 standard. Any information on nominal capacities in the present application is preferably also based on these standards.

### Embodiment as a Sodium-Ion Energy Storage Element

In further embodiments, the energy storage element may also be a sodium-ion cell, a potassium-ion cell, a calcium-ion cell, a magnesium-ion cell or an aluminum-ion cell. Among these variants, energy storage elements with sodium-ion cell chemistry are preferred.

Preferably, the sodium ion-based energy storage element comprises an electrolyte comprising at least one of the following solvents and at least one of the following conducting salts:

Organic carbonates, ethers, nitriles and mixtures thereof are particularly suitable as solvents. Preferred examples are
Carbonates: Propylene carbonate (PC), ethylene carbonate-propylene carbonate (EC-PC), propylene carbonate-dimethyl carbonate-ethyl methyl carbonate (PC-DMC-EMC), ethylene carbonate-diethyl carbonate (EC-DEC), ethylene carbonate-dimethyl carbonate (EC-DMC), ethylene carbonate-ethyl methyl carbonate (EC-EMC), ethylene carbonate-dimethyl carbonate-ethyl methyl carbonate (EC-DMC-EMC), ethylene carbonate-dimethyl carbonate-diethyl carbonate (EC-DMC-DEC)
Ethers: tetrahydrofuran (THF), 2-methyltetrahydrofuran, dimethyl ether (OME), 1,4-dioxane (DX), 1,3-dioxolane (DOL), diethylene glycol dimethyl ether (DEGDME), tetraethyl glycol dimethyl ether (TEGDME)
Nitriles: Acetonitrile (ACN), adiponitrile (AON), y-butyrolactone (GBL)

Trimethyl phosphate (TMP) and tris(2,2,2-trifluoroethyl) phosphate (TFP) can also be used.

Preferred conductive salts are: NaPF₆, sodium difluoro (oxalato) borate (NaBOB), NaBF₄, sodium bis(fluorosulfonyl)imide (NaFSI), sodium 2-trifluoromethyl-4,5-dicyanoimidazole (NaTDI), sodium bis(trifluoromethanesulfonyl)imide (NaTFSI), NaAsF₆, NaBF₄, NaClO₄, NaB(C₂O₄)₂, NaP(C₆H₄O₂)₃; NaCF₃SO₃, sodium triflate (NaTf) and Et₄NBF₄.

In preferred embodiments, additives may be added to the electrolyte. Examples of preferred additives, in particular for stabilization, are the following:

Fluoroethylene carbonate (FEC), transdifluoroethylene carbonate (DFEC), ethylene sulfite(ES), vinylene carbonate (VC), bis(2,2,2-trifluoroethyl)ether (BTFE), sodium 2-trifluoromethyl-4,5-dicyanoimidazole (NaTDI), sodium bis(fluorosulfonyl)imide (NaFSI), aluminum chloride (AICI₃), ethylene sulfate (DTD), sodium difluorophosphate (NaPO₂F₂), sodium difluoro(oxalato)borate (NaODFB), sodium difluorobisoxalatophosphate (NaDFOP) and tris(trimethylsilyl)borate (TMSB).

The negative electrode material of an energy storage element based on sodium ions is preferably at least one of the following materials:
carbon, especially hard carbon (pure or with nitrogen and/or phosphorus doping) or soft carbon or graphene-based materials (with N-doping); carbon nanotubes, graphite Phosphorus or sulphur (conversion anode)
Polyanions: Na₂Ti₃O₇, Na₃Ti₂(PO₄)₃, TiP₂O₇, TiNb₂O₇, Na—Ti—(PO₄)₃, Na—V—(PO₄)₃
Prussian blue: low-Na variant (for systems with aqueous electrolyte)
Transition metal oxides: V₂O₅, MnO₂, TiO₂, Nb₂O₅, Fe₂O₃, Na₂Ti₃O₇, NaCrTiO₄, Na₄TisO₁₂
MXenes with M=Ti, V, Cr, Mo or Nb and A=AI, Si, and Ga and X═C and/or N, e.g. Ti₃C₂
Organic: e.g. Na terephthalates (Na₂C₈H₂O₄)

Alternatively, a sodium metal anode can also be used on the anode side.

The positive electrode material of an energy storage element based on sodium ions may comprise or is, for example, at least one of the following materials:
Polyanions: NaFePO₄ (Triphylit-Type), Na₂Fe(P₂O₇), Na₄Fe₃(PO₄)₂(P₂O₇), Na₂FePO₄F, Na/Na₂[Fe_{1/2}Mn_{1/2}]PO₄F, Na₃V₂(PO₄)₂F₃, Na₃V₂(PO₄)₃, Na₄(CoMnNi)₃(PO₄)₂P₂O₇, NaCoPO₄, Na₂CoPO₄F
Silicates: Na₂MnSiO₄, Na₂FeSiO₄
Layered oxides: NaCoO₂, NaFeO₂, NaNiO₂, NaCrO₂, NaVO₂, NaTiO₂, Na(FeCo)O₂, Na(NiFeCo)₃O₂, Na(NiFeMn)O₂, and Na(NiFeCoMn)O₂, Na(NiMnCo)O₂

In addition, the electrodes of an energy storage element preferably contain an electrode binder and/or an additive to improve the electrical conductivity. The active materials are preferably embedded in a matrix of the electrode binder, whereby the active materials are preferably used in particulate form and adjacent particles in the matrix are preferably in direct contact with each other. Conductive agents have the function of elevating the electrical conductivity of the electrodes. Common electrode binders are based on polyvinylidene fluoride (PVDF), (Na) polyacrylate, styrene-butadiene rubber, (Na) alginate or carboxymethyl cellulose, for example, or mixtures of different binders. Common conductive agents are carbon black, fine graphite, carbon fibers, carbon nanotubes and metal powder.

In a preferred energy storage element based on sodium-ion technology, both the anode and the cathode current collector consist of aluminum or an aluminum alloy. The housing and the contact plates as well as any other current conductors within the housing can also consist of aluminum or the aluminum alloy.

### Preferred Design of the Housing

Preferably, the energy storage element is characterized by at least one of the following features a. to c:

a. The central section and the closure section are separated by an indentation that circumferentially surrounds the outside of the housing cup.

b. The housing cup has an identical maximum outer diameter in the central section and the closure section.

c. In the region of the indentation, the outer diameter of the housing cup is reduced by 4 to 12 times the wall thickness of the housing cup in this region.

It is preferred that at least the immediately preceding features a. and b. are realized in combination. It is preferred that all three immediately preceding features a. to c. are realized in combination.

Preferably, the annular seal is compressed in the closure section. It is preferably pressed radially against the circular edge of the pole cap and/or the first metal disc.

### Embodiments of the Contact Sheet Metal Member

In principle, the contact sheet metal member can be electrically connected to the anode current collector or the cathode current collector.

In a preferred embodiment, a contact sheet metal member electrically connected to the anode current collector is characterized by at least one of the following features a. and b:

a. The contact sheet metal member consists of nickel or copper or titanium or a nickel or copper or titanium alloy or stainless steel, for example of type 1.4303 or 1.4404 or of type SUS304, or of nickel-plated copper.

b. The contact sheet metal member consists of the same material as the anode current collector.

In another preferred embodiment, a contact sheet metal member electrically connected to the cathode current collector is characterized by at least one of the following features a. and b:

a. The contact sheet metal member consists of aluminum or an aluminum alloy.

b. The contact sheet metal member consists of the same material as the anode current collector.

Preferably, the contact sheet metal member electrically connected to the anode current collector and/or the contact sheet metal member electrically connected to the cathode current collector are characterized by at least one of the two features a. and b. immediately below:

a. The contact sheet metal member has a preferably uniform thickness in the range from 50 μm to 600 μm, preferably in the range from 150 μm to 350 μm.

b. The contact sheet metal member is dimensioned such that it covers at least 40%, preferably at least 70%, preferably at least 80% of the first terminal end face or the second terminal end face.

It is preferred that the immediately preceding features a. and b. are realized in combination with each other.

Covering as much of the end face as possible is important for the thermal management of the energy storage element. The larger the cover, the easier it is to contact large parts of the first longitudinal edge of the respective current collector or even to make contact over its entire length. Heat formed in the electrode-separator assembly can thus be dissipated well via the contact sheet metal member.

Preferably, the bottom side of the second contacting section of the contact sheet metal member sits flat on the first longitudinal edge of the current collector to which it is welded. Ideally, it is in contact with the longitudinal edge over a large part of its length or over its entire length.

In some embodiments, it has proven advantageous to subject the longitudinal edge of the current collector to a pretreatment before the contact sheet metal member is placed on it. In particular, at least one depression can be folded into the longitudinal edge, which corresponds to the at least one bead or the elongated elevation on the bottom side of the second contacting section of the contact sheet metal member.

The longitudinal edge of the current collector may also have been subjected to directional forming by pre-treatment. For example, it can be bent in a defined direction.

Preferably, the contact sheet metal member is welded to the first longitudinal edge of the respective current collector in the region of the bead, in particular via one or more weld seams or weld spots within the bead.

### Preferred Embodiments of Current Collectors and Separators

The anode current collector, the cathode current collector and the separator or separators of the energy storage element preferably have the following dimensions:
A length in a range from 0.5 m to 25 m
A width in a range from 40 mm to 145 mm

If the electrode-separator assembly is formed as a winding, the ribbon-shaped anode, the ribbon-shaped cathode and the ribbon-shaped separator(s) are preferably wound in a spiral. To produce the electrode-separator assembly, the ribbon-shaped electrodes and the ribbon-shaped separator(s) are generally fed to a winding device, where they are preferably wound in a spiral around a winding axis. Bonding of the electrodes and separators or contacting at elevated temperatures is usually not necessary. In some embodiments, the electrodes and the separator or separators are wound onto a cylindrical or hollow-cylindrical winding core, which is seated on a winding mandrel and remains in the winding after winding.

The winding shell can be formed by a plastic film or an adhesive tape, for example. It is also possible for the winding shell to be formed by one or more separator windings.

The current collectors of the energy storage element have the function of electrically contacting electrochemically active components contained in the respective electrode material over as large an area as possible. Preferably, the current collectors consist of a metal or are at least metallized on the surface.

In the case of a lithium-ion cell, suitable metals for the anode current collector are, for example, copper or nickel or other electrically conductive materials, in particular copper and nickel alloys or metals coated with nickel. In particular, materials of type EN CW-004A or EN CW-008A with a copper content of at least 99.9% can be used as copper alloys. Alloys of the type NiFe, NiCu, CuNi, NiCr and NiCrFe are particularly suitable as nickel alloys. Alloys of the type NiFe, NiCu, CuNi, NiCr and NiCrFe are particularly suitable as nickel alloys. Stainless steel can also be considered, for example type 1.4303 or 1.4404 or type SUS304.

In the case of a lithium-ion cell, aluminum or other electrically conductive materials, including aluminum alloys, are particularly suitable as a metal for the cathode current collector.

Suitable aluminum alloys for the cathode current collector are, for example, Al alloys of type 1235, 1050, 1060, 1070, 3003, 5052, Mg3, Mg212 (3000 series) and GM55. AlSi, AlCuTi, AlMgSi, AlSiMg, AlSiCu, AlCuTiMg and AlMg are also suitable. The aluminum content of these alloys is preferably above 99.5%.

Preferably, the anode current collector and/or the cathode current collector are each a ribbon-shaped metal foil with a thickness in the range from 4 μm to 30 μm.

In addition to foils, however, other strip-shaped substrates such as metallic or metallized nonwovens or open-pored metallic foams or expanded metals can also be used as current collectors.

The current collectors are preferably loaded with the respective electrode material on both sides.

It is preferred that the longitudinal edges of the separator or separators form the end faces of the electrode-separator assembly.

### Preferred Embodiments of the Lid Assembly

The energy storage element is preferably characterized by the fact that a CID function is integrated into the lid assembly, which ensures that if the pressure in the cell is too high, the pressure can escape from the housing and at the same time the electrical contact between the lid assembly and the electrode-separator assembly can break off.

Preferably, the energy storage element is characterized by at least one of the following features a. and b:

a. The first metal disc of the lid assembly comprises a metallic membrane that bulges outwards or bursts when there is a certain excess pressure inside the housing.

b. The first metal disc comprising the membrane is in direct contact with the top side of the first contacting section of the contact sheet metal member.

It is preferred that the immediately preceding features a. and b. are realized in combination.

### Possible Designs of the Seal

It is preferred that the energy storage element is characterized by at least one of the immediately following features a. and b:

a. The seal consists of a plastic material that has a melting point>200° C., preferably>300° C., preferably a melting point>300° C. and <350° C.

b. The plastic material is a polyether ether ketone (PEEK), a polyimide (PI), a polyphenylene sulphide (PPS) or a polytetrafluoroethylene (PTFE).

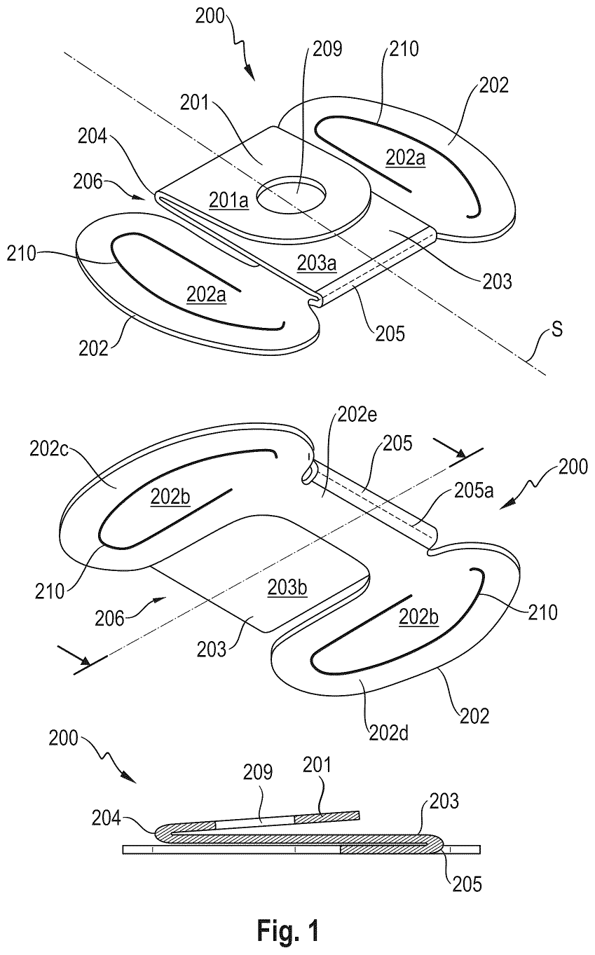

It is preferred that the immediately preceding features a. and b. are realized in combination.
FIG. 1 shows a preferred embodiment of a contact sheet metal member 200 in a top view (upper figure) and in a bottom view (middle figure). Furthermore, a cross-section of the contact sheet metal member 200 along the line S is shown (lower figure). The contact sheet metal member 200 comprises a first terminal contacting section 201 with a top side 201a and a bottom side 201b, which is provided for contacting with a first component of an energy storage element, and a second terminal contacting section 202 with a top side 202a and a bottom side 202b, which is provided for contacting with a second component of an energy storage element. Between the first contacting section 201 and the second contacting section 202, the contact sheet metal member 200 comprises a connecting section 203 with a top side 203a and a bottom side 203b. As a result of a bending process, the top side 203a of the connecting section 203 here faces the bottom side 201b of the first contacting section 201 and the bottom side 203b of the connecting section 203 faces the top side 202a of the second contacting section 202. The first contacting section 201 and the connecting section 203 are connected to each other via a first bending zone 204, in which the contact sheet metal member 200 is bent along a first bending line. The second contacting section 202 and the connecting section 203 are connected to each other via a second bending zone 205, in which the contact sheet metal member 200 is bent along a second bending line. As a result of the aforementioned bending processes, the connecting section 203 is aligned parallel to the second contacting section 202, while it forms an angle with the first contacting section 201 in the range from −10° to +30°. The contact sheet metal member 200 has the same thickness in the connecting section 203 as in the first contacting section 201 and in the second contacting section 202. This can for example be in a range from 50 μm to 600 μm, preferably in a range from 150 μm to 350 μm.

The contact sheet metal member 200 comprises in each of the first contacting section 201, the second contacting section 202 and the connecting section 203 only regions which extend in a planar layer, respectively. The planar layer here is a non-curved layer with a uniform thickness, which essentially corresponds to the thickness of the contact sheet metal member 200 in the respective section. Since the connecting section 203 is not parallel to the first contacting section 201, the planar layer, in which the regions of the connecting section 203 extend, typically intersects the planar layer, in which the regions of the first contacting section extend, along the bending line.

The second contacting section 202 has a recess 206, which forms a receptable for the first bending zone 204. The first bending zone 204 can be pressed into this receptable, for example during installation of the contact sheet metal member 200. The receptable 206 is formed by the two legs 202c and 202d, which are connected to each other by the crossmember 202e. The crossmember is sufficiently long so that the first bending zone 204 can be pressed into the receptable without touching one of the legs 202c and 202d.

The recess 206 is located in the same planar layer in which the regions or the first region of the second contacting section 202 extend.

The first contacting section 201 has an aperture 209.

Along the lines 210, for example, the contact sheet metal member 200 can be welded to the edge of a current collector protruding from an end face of an electrode-separator assembly.

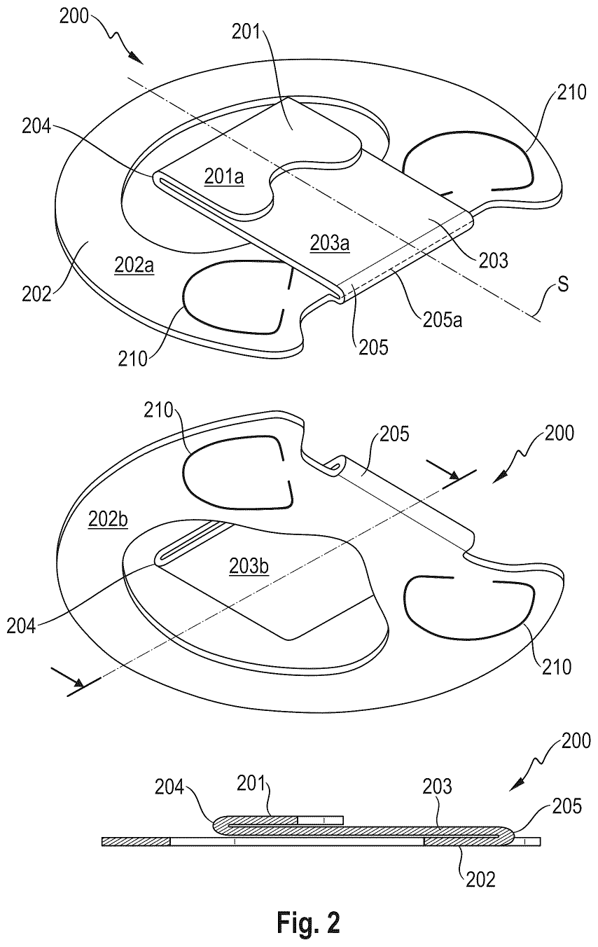

FIG. 2 shows a further preferred embodiment of a contact sheet metal member 200 in a top view (upper figure) and in a bottom view (middle figure). Furthermore, a cross-section of the contact sheet metal member 200 along the line S is shown (lower figure). The contact sheet metal member 200 comprises a first terminal contacting section 201 having a top side 201a and a bottom side 201b, which is provided for contacting with a first component of an energy storage clement, and a second terminal contacting section 202 having a top side 202a and a bottom side 202b, which is provided for contacting with a second component of an energy storage element. Between the first contacting section 201 and the second contacting section 202, the contact sheet metal member 200 comprises a connecting section 203 with a top side 203a and a bottom side 203b. As a result of a bending process, the top side 203a of the connecting section 203 faces the bottom side 201b of the first contacting section 201 and the bottom side 203b of the connecting section 203 faces the top side 202a of the second contacting section 202. The first contacting section 201 and the connecting section 203 are connected to each other via a first bending zone 204, in which the contact sheet metal member 200 is bent along a first bending line. The second contacting section 202 and the connecting section 203 are connected to each other via a second bending zone 205, in which the contact sheet metal member 200 is bent along a second bending line. As a result of the aforementioned bending process, the connecting section 203 is aligned parallel to the first contacting section 201 and to the second contacting section 202. The contact sheet metal member 200 has the same thickness in the connecting section 203 as in the first contacting section 201 and in the second contacting section 202. This can typically be in a range from 50 μm to 600 μm, preferably in a range from 150 μm to 350 μm.

The contact sheet metal member 200 comprises in each of the first contacting section 201, the second contacting section 202 and the connecting section 203 only regions which extend in a planar layer, respectively. The planar layer here is a non-curved layer with a uniform thickness, which essentially corresponds to the thickness of the contact sheet metal member 200 in the respective section. Since the connecting section 203 is parallel to the contacting sections 201 and 202, the planar layers in which the regions of the connecting section 203 and the contacting sections 201 and 202 extend, also do not intersect.

The second contacting section 202 has an oval aperture 207, which forms a receptable for the first bending zone 204. The first bending zone 204 can be pressed into this receptable, for example during installation of the contact sheet metal member 200. The aperture 207 is sufficiently large that the first bending zone 204 can be pressed into the receptable without touching an edge of the aperture.

The aperture 207 is located in the same planar layer in which the regions or the first region of the second contacting section 202 extend, and is framed by the regions or first region.

Along the lines 210, for example, the contact sheet metal member 200 can be welded to the edge of a current collector protruding from an end face of an electrode-separator assembly.

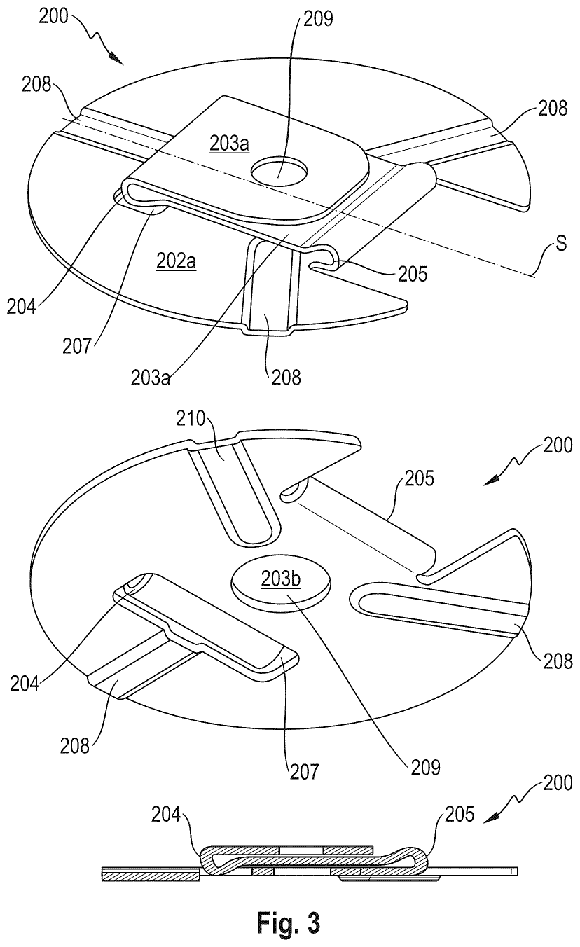

FIG. 3 shows a further preferred embodiment of a contact sheet metal member 200 in a top view (upper figure) and in a bottom view (middle figure). Furthermore, a cross-section of the contact sheet metal member 200 along the line S is shown (lower figure). The contact sheet metal member 200 comprises a first terminal contacting section 201 having a top side 201a and a bottom side 201b, which is provided for contacting with a first component of an energy storage element, and a second terminal contacting section 202 having a top side 202a and a bottom side 202b, which is provided for contacting with a second component of an energy storage element. Between the first contacting section 201 and the second contacting section 202, the contact sheet metal member 200 comprises a connecting section 203 with a top side 203a and a bottom side 203b. As a result of a bending process, the top side 203a of the connecting section 203 faces the bottom side 201b of the first contacting section 201 and the bottom side 203b of the connecting section 203 faces the top side 202a of the second contacting section 202. The first contacting section 201 and the connecting section 203 are connected to each other via a first bending zone 204, in which the contact sheet metal member 200 is bent along a first bending line. The second contacting section 202 and the connecting section 203 are connected to each other via a second bending zone 205, in which the contact sheet metal member 200 is bent along a second bending line. As a result of the aforementioned bending process, the connecting section 203 is aligned parallel to the first contacting section 201 and the second contacting section 202. The contact sheet metal member 200 has the same thickness in the connecting section 203 as in the first contacting section 201 and the second contacting section 202. This can typically be in a range from 50 μm to 600 μm, preferably in a range from 150 μm to 350 μm.

The contact sheet metal member 200 has three star-shaped beads 208 in the second contacting section 202, which appear as a depression on the top side 202a of the second contacting section 202 and as an elevation on the bottom side 202b. In these beads 208, the contact sheet metal member 200 can be welded to the edge of a current collector protruding from an end face of an electrode-separator assembly.

In the first contacting section 201 and in the connecting section 203, the contact sheet metal member 200 comprises only regions that extend in the same planar layer. In contrast, in the second contacting section 202, the contact sheet metal member 200 comprises a first region that extends in a planar layer and at least one second region that does not extend in this planar layer. Namely, in the second contacting section 202, the contact sheet metal member 200 comprises the three beads 208, and the at least one second region comprises in each case the region of the depression or elevation that does not extend in the plane of the first region.

The second contacting section 202 has a slot-shaped aperture 207, which forms a receptable for the first bending zone 204. The aperture 207 lies in the planar layer in which the regions or the first region of the second contacting section 202 extend, and is framed by the regions or the first region. The first bending zone 204 protrudes into the receptable and thus also into the planar layer in which the regions or the first region of the second contacting section 202 extend. The aperture 207 is sufficiently large that the first bending zone 204 can be pressed into the receptable without touching an edge of the aperture 207.

The first contacting section 201 has an aperture 209. The second contacting section 202 has an additional aperture 209.

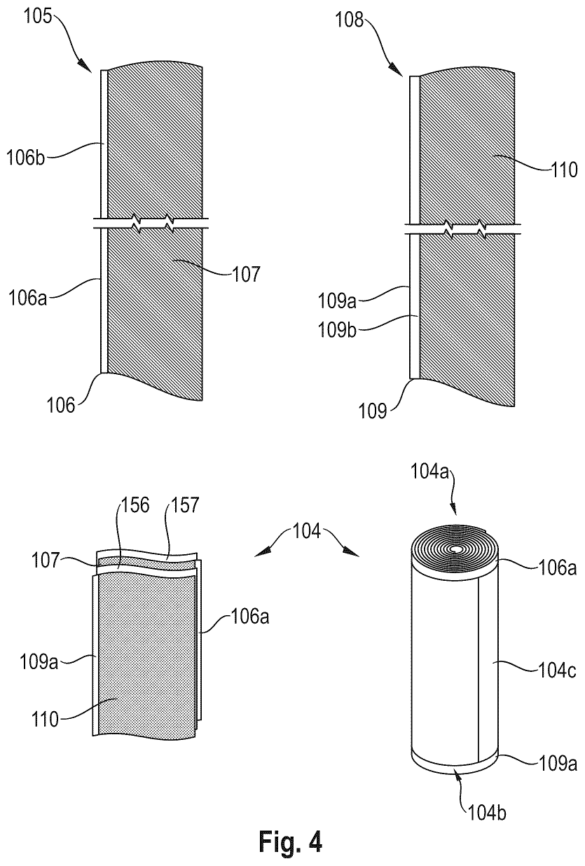

FIG. 4 illustrates the structure of an electrode-separator assembly 104, which can be a component of an energy storage element. The assembly 104 comprises the ribbon-shaped anode 105 with the ribbon-shaped anode current collector 106, which has a first longitudinal edge 106a and a second longitudinal edge parallel thereto. The anode current collector 106 is a foil made of copper or nickel. It comprises a strip-shaped main region, which is loaded with a layer of negative electrode material 107, and a free edge strip 106b, which extends along its first longitudinal edge 106a and which is not loaded with the electrode material 107. Further, the assembly 104 comprises the ribbon-shaped cathode 108 with the ribbon-shaped cathode current collector 109 having a first longitudinal edge 109a and a second longitudinal edge parallel thereto. The cathode current collector 109 is an aluminum foil. It comprises a strip-shaped main region, which is loaded with a layer of positive electrode material 110, and a free edge strip 109b, which extends along its first longitudinal edge 109a and which is not loaded with the electrode material 110. Both electrodes are shown individually in an unwound state.

The anode 105 and the cathode 108 are arranged offset from each other within the electrode-separator assembly 104, so that the first longitudinal edge 106a of the anode current collector 106 protrudes from the first terminal end face 104a and the first longitudinal edge 109a of the cathode current collector 109 protrudes from the second terminal end face 104b of the electrode-separator assembly 104. The offset arrangement can be seen in the illustration at the bottom left. The two ribbon-shaped separators 156 and 157 are also shown there, which separate the electrodes 105 and 108 from each other in the winding.

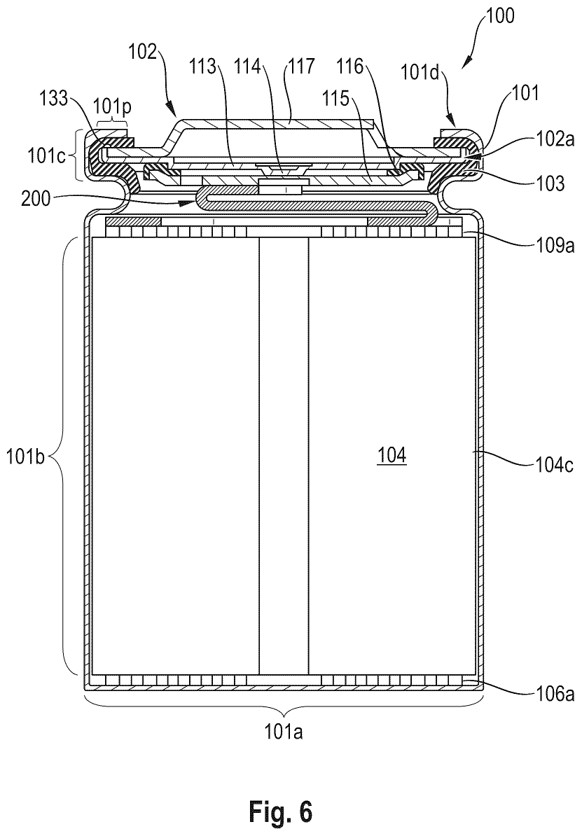

In the illustration at the bottom right, the electrode-separator assembly 104 is shown in wound form, as it can be used in an energy storage cell according to FIG. 6, for example. The electrode edges 106a and 109a protruding from the end faces 104a and 104b are clearly visible. The winding shell 104c is formed by a plastic film.

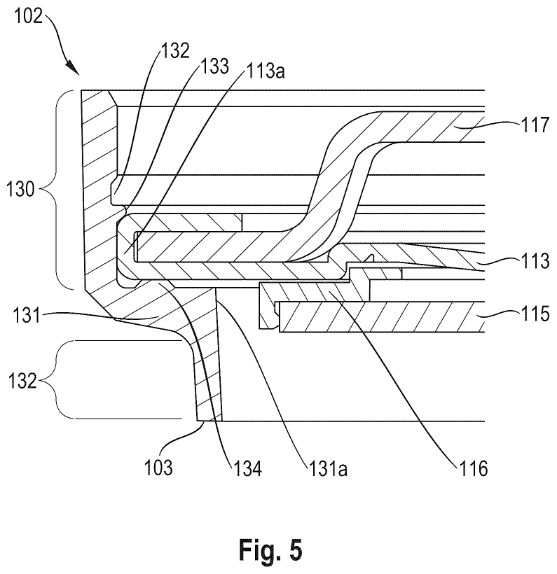

The lid assembly 102 shown in FIG. 5 comprises the pole cap 117, the first metal disc 113, the second metal disc 115, the annular seal 103 and the annular insulator 116. The first metal disc 113 is arranged between the pole cap 117 and the second metal disc 115. The annular insulator 116 electrically insulates the first metal disc 113 from the second metal disc 115, whereas the first metal disc 113 is in direct contact with the pole cap 117.

The annular seal 103 is mounted on the circular edge of the first metal disc 113, which is folded over in a U-shape around the edge of the pole cap 117.

The seal 103 comprises an outer annular segment 130 which opens at its lower end into an inwardly pointing collar 131 which narrows the outer annular segment 130 at this end. The collar 131 has an inner edge 131a, which merges into the inner annular segment 132, which has a smaller diameter than the outer annular segment 130.

FIG. 6 shows an energy storage cell 100 with an airtight and liquid-tight housing which comprises a metallic housing cup 101 with a terminal circular opening and a lid assembly 102 with a circular edge 102a which closes the circular opening. The lid assembly 102 has a similar structure to the lid assembly shown in FIG. 5. The seal 103 consists of an electrically insulating material and encloses the circular edge 102a of the lid assembly 102 and electrically insulates the housing cup 101 and the lid assembly 102 from each other. The housing cup 101 comprises in axial sequence a bottom 101a, a central section 101b and a closure section 101c, wherein the central section 101b is cylindrical and in the central section 101b the winding shell 104c of the electrode-separator assembly 104, which is formed as a winding, is in contact with the inside of the housing cup 101, and in the closure section 101c the annular seal 103 is in press contact with the lid assembly 102 and the inside of the housing cup 101. In the closure section 101c, the housing cup 101 has an opening edge 101d defining the circular opening, which is bent radially inwards over the edge 102a of the lid assembly 102 enclosed by the seal 103 and which positively fixes the lid assembly 102 including the seal 103 in the circular opening of the housing cup 101.

The cell 100 also comprises an electrode-separator assembly 104 in the form of a cylindrical winding with the sequence anode/separator/cathode, which, however, is only shown schematically here. The longitudinal edge 106a of the anode current collector 106 protrudes from the end face 104a of the electrode-separator assembly 104, and the longitudinal edge 109a of the anode current collector 109 protrudes from the end face 104b of the electrode-separator assembly 104. The longitudinal edge 106a is welded, preferably over its entire length, directly to the housing bottom 101a. The longitudinal edge 109a is, preferably over its entire length, directly connected to a contact sheet metal member 200 according to the embodiment shown in FIG. 2. Here, the second contacting section 202 rests with its bottom side 202b on the longitudinal edge 109a. Preferably, the longitudinal edge 109a is welded to the bottom side 202b. The top side 201a of the first contacting section 201 rests directly on the second metal disc 115 and is connected thereto by welding.

The cell 100 has a height in the range from 60 mm to 10 mm, for example, and its diameter is preferably in a range from 20 mm to 50 mm. The housing cup 101 usually has a wall thickness in a range from 0.1 mm to 0.3 mm in the central section 101b. The radially inwardly bent opening edge 101d of the housing cup 101 is thicker by a factor in the range from 1.5 to 2than the housing cup 101 in the central section 101b. It comprises a first, inner side, which is in direct contact with the seal 103, and a second side facing away from the seal 103. The second side comprises the annulus-shaped flat surface 101p. The flat surface is preferably characterized by annulus width in a range from 0.8 mm to 3 mm and preferably forms an angle of 90° with the wall of the housing cup 101 in the central section 101b. There is a maximum height difference of 0.08 mm between the highest and the lowest point of the annulus-shaped flat surface.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of clements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, c.g., A and B, or the entire list of elements A, B and C.

What is claimed is:

1. A contact sheet metal member, comprising:
a first contacting section configured for contacting a first component of an energy storage element, the first contacting section comprising a top side and a bottom side;
a second contacting section configured for contacting a second component of an energy storage element, the second contacting section having a top side and a bottom side;
a connecting section disposed between the first contacting section and the second contacting section, the connecting section having a top side and a bottom side, wherein the top side of the connecting section faces the bottom side of the first contacting section and the bottom side of the connecting section faces the top side of the second contacting section;
a first bending zone in which the contact sheet metal member is bent along at least one bending line, the first bending zone connecting the first contacting section and the connecting section; and
a second bending zone in which the contact sheet metal member is bent along at least one second bending line, the second bending zone connecting the second contacting section and the connecting section,
wherein the second contacting section has a recess or an aperture that forms a receptable for the first bending zone.

2. The contact sheet metal member according to claim 1, wherein at least one of:
the first contacting section is aligned parallel to the second contacting section,
the connecting section is aligned parallel to the first contacting section and/or the second contacting section, and/or
the connecting section forms an angle in the range from −10° to +30° with the first contacting section and/or the second contacting section.

3. The contact sheet metal member according to claim 1, wherein at least one of:
the contact sheet metal member has a uniform thickness in the first contacting section, the second contacting section, and in the connecting section, and/or
the contact sheet metal member has the same thickness in the connecting section as in the first contacting section and/or in the second contacting section.

4. The contact sheet metal member according to claim 1, wherein the contact sheet metal member has at least one bead in the second contacting section that provides a depression on the top side of the second contacting section and an elevation on the bottom side of the second contacting section.

5. The contact sheet metal member according to claim 1, wherein at least one of:
in the first contacting section, the contact sheet metal member comprises only regions extending in a same planar layer,
in the second contacting section, the contact sheet metal member comprises only regions extending in the same planar layer, and/or
in the connecting section, the contact sheet metal member comprises only regions extending in the same planar layer.

6. The contact sheet metal member according to claim 1, wherein at least one of:
in the first contacting section, the contact sheet metal member comprises only regions extending in a same planar layer,
in the second contacting section, the contact sheet metal member comprises a first region extending in a planar layer and at least one second region not extending in the planar layer, and/or
in the connecting section, the contact sheet metal member comprises only regions that extend in the same planar layer.

7. The contact sheet metal member according to claim 1, wherein at least one of:
the first contacting section is a terminal contacting section, and/or
the second contacting section is a terminal contacting section.

8. The contact sheet metal member according to claim 1, wherein the first contacting section, the second contacting section, and the connecting section each have a respective aperture, the respective apertures overlapping with each other in a direction perpendicular to the second contacting section and/or forming a passage through sections of the contact sheet metal member.

9. An energy storage element comprising a contact sheet metal member according to claim 1.

10. The energy storage element of claim 9, further comprising at least one of:
an electrode-separator assembly with a sequence anode/separator/cathode;
a housing closed in an airtight and liquid-tight manner and in which the electrode-separator assembly is arranged;
the electrode-separator assembly is electrically connected via the contact sheet metal member to a part of the housing or to an electrical pole passing through the housing.

11. The energy storage element of claim 9, wherein at least one of:
the electrode-separator assembly is in a form of a cylindrical winding with a first terminal end face, a second terminal end face, and a winding shell therebetween;
the anode of the electrode-separator assembly comprises an anode current collector having a first longitudinal edge and a second longitudinal edge parallel thereto;
the anode current collector comprises a main region loaded with a layer of negative electrode material and a free edge strip extending along its first longitudinal edge which is not loaded with the negative electrode material;
the cathode of the electrode-separator assembly comprises a cathode current collector having a first longitudinal edge and a second longitudinal edge parallel thereto;
the cathode current collector comprises a main region loaded with a layer of positive electrode material and a free edge strip extending along its first longitudinal edge which is not loaded with the positive electrode material; and/or
the anode and the cathode are arranged within the electrode-separator assembly such that the first longitudinal edge of the anode current collector protrudes from the first terminal end face and the first longitudinal edge of the cathode current collector protrudes from the second terminal end face of the electrode-separator assembly.

12. The energy storage element of claim 11, wherein at least one of:
the housing comprises a metallic housing cup with a terminal circular opening and a lid assembly with a circular edge that closes the circular opening;
the top side of the first contacting section is fixed to the lid assembly; and/or
the bottom side of the second contacting section is fixed to a longitudinal edge of one of the current collectors protruding from one of the end sides of the electrode-separator assembly.

13. The energy storage element of claim 12, wherein at least one of:
the lid assembly comprises a pole cap with a circular edge;
the lid assembly comprises a first metal disc having a circular edge;
the lid assembly comprises a second metal disc with a circular edge;
the lid assembly comprises annular seal;
the lid assembly comprises an annular insulator;
the first metal disc is arranged between the pole cap and the second metal disc;
the annular insulator electrically insulates the first metal disc and the second metal disc from each other;
the first metal disc is in direct contact with the pole cap;
the annular seal is mounted on the circular edge of the pole cap and/or the first metal disc; and/or
the top side of the first contacting section is welded to the second metal disc.
